(19) United States
(12) Patent Application Publication
(10) Pub. No.: US 2015/0350208 A1
(43) Pub. Date: Dec. 3, 2015

(54) TOKEN SERVER-BASED SYSTEM AND METHODOLOGY PROVIDING USER AUTHENTICATION AND VERIFICATION FOR ONLINE SECURED SYSTEMS

(71) Applicant: Turgut BAYRAMKUL, Laguna Niguel, CA (US)

(72) Inventor: Turgut BAYRAMKUL, Laguna Niguel, CA (US)

(21) Appl. No.: 14/288,372

(22) Filed: May 27, 2014

(51) Int. Cl. H04L 29/06; G06F 21/35; G06F 21/34

(52) U.S. Cl. CPC H04L 63/0884; G06F 21/34; G06F 21/35; H04L 63/0853

(57) ABSTRACT

One embodiment of the invention could be a method of authenticating a requesting party's request to access to a secure system or website as entity authorized to access the secure system or website, the method comprising of the following steps: sending via a first communication network from the secure system or website an user authentication request associated with an identifier for an authorized user's communication device; receiving by the token server user the user authentication request, generating a token by the token server, transmitting the token via a second an different communication network to user's communication device, using a receipt by the token server of the token sent back by the user's communication device to determine whether or not a requesting entity of the secure system or website is an entity authorized by the secure system or website to access the secure system or website

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention generally relates to user authentication and verification methods and systems for secured online sites. More particularity to those user access and verification methods and systems that substantially use a token server in conjunction with a communication means that is different from another communications means being used to access the secured online site.

### BACKGROUND

One of the pressing matters relating to online activities occurring through the World Wide Web (www) and other server-based systems is to limit access to secured systems only to those entities that have proper authority to access such secured systems in the first place (e.g., true customers/authorized users.) Many times, these online secured systems and their databases are compromised, “hacked” or otherwise broken into by unauthorized third parties sometimes causing significant damage to those secured systems that may result in data destruction, data theft, revenue loss, identify theft, monetary damages, and the like.

What could be needed is a user authentication/verification system and method that may employ a token server for verification purposes whenever a respective secured system/site may be accessed/used allegedly in the name of the authorized entity (e.g., a true and authorized user or customer of the online secured system.) In such circumstances, when an access request is made by such requesting entity through a first communication means, the user authentication/verification system may cause the token server to create and send a unique one-time token to a second communication means being different from the first communication means, the second communication means known by respective secured system/site to belong the true authorized user or customer that the requesting user alleges to be. The token is sent to the second communication means that is presumed to generally in the possession of the authorized user or customer. The token then generally needs to be timely returned to the token server by second communication means to substantially allow access to respective secured system/site by the requesting entity as being confirmed by invention as an authorized user/customer of the respective secured system/site.

If the access is by a requesting entity that is not an allegedly authorized user or customer, then the requesting entity should not having access to the second communication and the token delivered to it. As such, the requesting entity then lacks the ability to obtain the token and to return it to the token server through the first communication means. The token server then times out for lack of token return allowing the user authentication/verification system to inform the respective secured system/site to block access by the requesting entity. The invention may also allow notification of the authorized user upon receipt of the occurrence of unauthorized activity so the authorized user/respective secured system/web site can take appropriate steps to protect its/their interests in the matter.

### SUMMARY OF ONE EMBODIMENT OF THE INVENTION

### Advantages of One or More Embodiments of the Present Invention

The various embodiments of the present invention may, but do not necessarily, achieve one or more of the following advantages:

to provide a system and method of properly identifying a requesting entity trying to access a secured system as having proper permission and authority to access to the secured system using a second communication means different from a first communication means being used by the requesting entity to access the online secured system;

the ability to have a token server, upon an access request by an allegedly authorized requesting entity of a secured system/site, to create and send a token to known communication device of an authorized entity of the respective secured system/web site, token being returned to the token server to validate the access sought as being by the authorized user/customer of a respective secured system or site;

to provide a token server authentication system whereby receipt of a token by the customer/authorized user of secured system or web site informs the customer/authorized user of possible irregularities in the secured system or site as to their usage; and

the ability of an authorized entity of a secured site or system to return a token given to authorized entity by a secondary communication device not being used to access the secured site or system as a way of gaining access or otherwise transact with the respective secured site or system.

These and other advantages may be realized by reference to the remaining portions of the specification, claims, and abstract.

### BRIEF DESCRIPTION OF ONE EMBODIMENT OF THE PRESENT INVENTION

One possible embodiment of the invention could be A method of authenticating a requesting party using a first communication device to access a secure system or website as an authorized user of the secure system or website, the authorized user having a user account with the secure system or website, the method comprising of the following steps, but not necessarily in the order shown: generating a request for authorized user authentication by the secure system or website, the request for authorized user authentication further containing an identifier of a second communication device that is associated with the authorized user, the second communication device being different from the first communication device; sending the request for authorized user authentication to a token server; generating the token by the token server; transmitting the token to the second communication device based on the identifier; and using the retransmission or lack of retransmission of the token from the second communication device back to the token server to confirm or deny authentication of the requesting entity as the authorized user allowed to access the secure system or website.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 shows substantially a schematic flow chart of one embodiment of method for using the present invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The present invention 10 could comprise of an authentication verification system and method 100 to which a subscriber of the invention 10 could access the invention 10 to help ensure that an entity trying to access the subscriber is authorized entity to which that subscriber has currently given permission to access the subscriber. The subscriber, for example, could be commercial entity that generally provides goods and/or services for remuneration or the like to its authorized entities (its true customers.) The subscriber could be a secured web portal, a secured data base or other secured entity having such communication capability that allows its authorized customer via computer, smart phone, or like communication device to access/transact with the subscriber's secured system or a site or a system or site having one or more secured portions.

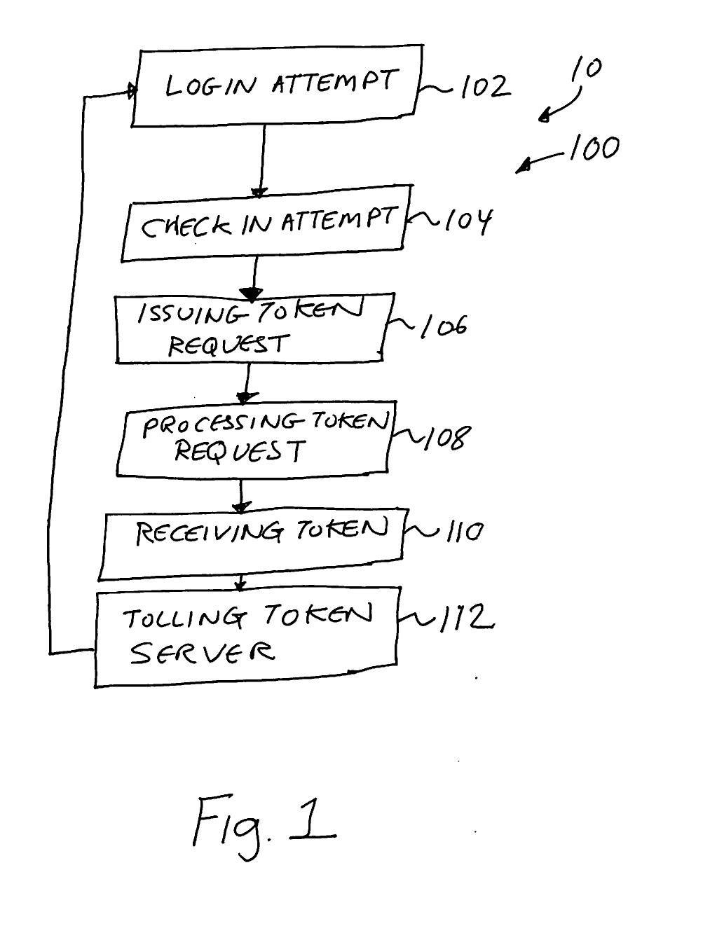

As shown in FIG. 1, the method or process 100 for this system 20 could start with a step 102, Log in attempt. In this step, a requesting entity using a first communication device (e.g., a lap top computer) connected to a first network (e.g., the internet) to access or otherwise transact with the subscriber could first transmit to the subscriber some preliminary form of access information or identification (e.g., a username and password previously setup between subscriber and authorized user for this purpose) to initially indicate to the subscriber that the requesting entity was an authorized entity/true customer properly seeking access to the subscriber. Upon the substantial completion of this step, the process 100 could proceed to step 104, Checkin Login

In step 104, check in login, the subscriber upon receiving this preliminary form of access information or identification checks this preliminary information against the subscriber's database of authorized user preliminary information. If there is a matchup between the sent and stored preliminary information, the subscriber could then retrieve the identifier of the authorized users second communication device (that is different from the first communication device) from another appropriate subscriber database of such information. As this step is substantially completed, the process 100 could proceed to step 106, issuing a token request.

In step 106, issuing token request, the subscriber associates the identifier and subscriber's company code (the information that identifies the subscriber to the invention) together to form an encrypted token request (e.g., authorized entity authentication request) and sends encrypted token request onto the token server of the system. As this step is substantially completed, the process 100 could proceed to step 108, processing the token request.

In step 108, processing the token request, the token server may first decrypt the token request to access its information. After comparing and matching the company code with the token server's data base of current subscriber's company code, the token server could process the token request. The token server can then generate a specific and unique token request identifier that the token server will associated with this specific incoming token request. The token server can send that token request identifier back to the subscriber so that the subscriber could approximately associate with the token request identifier with the specific access request, allowing the subscriber to poll the token server for updates on the token return receipt by the token server.

The token server could then generate a token (e.g., an alpha-numeric and or other symbol based code) that is unique to this token request and previously unknown to the authorized user. The token server using the identifier for the second communications device sent to the token server by the subscriber, could the send the code to the second communication device. The second communication device could be a different from the first communication device, as well as being a different type of a communications device from the first communication device. The first communication device could be a laptop computer wherein the second communication device is a cellar-based phone. The first communication device could be using a first network communication type (internet access) whereas the second communications device could be using a second network communication type (SMS or Short Message Service.) At the completion of step 108, the process could proceed to step 110, receiving the token.

In step 110, receiving token, if the requesting entity and the authorized entity were one and the requesting entity could receive the token with its instructions to send the token back to the token server using the second communication device on the second network (e.g., have the requesting party use SMS to send the token back to the token server within a certain time limit). Upon the token's return to the token server within a specified time limit, the token server could identify requesting entity and authorized entity as being one and the same. If the token is not properly and timely return to the token server within a specified time limit, the token server could identify requesting entity and authorized entity as not being one and the same. As this step is substantially completed, then the process could proceed to step 112, tolling the token server.

In step 112, tolling the token server, the subscriber using the identifier given to it by the token server for the respective token request could repeatedly poll or question the token server as to the results of the token generation and/or return. If the token server informs the subscriber that the requesting entity and true customer are not one and the same, then the subscriber can allow the requesting party to proceed with the requesting party's transactions with the subscriber.

If on the other hand, the token server informs the subscriber that the requesting entity and true customer are not one and the same, then the subscriber could deny the requesting entity access to or the authority to access the secured portions of the subscriber's system of network. The subscriber could then substantially alert authorized entity/the true customer as to possibility of improper action(s) being taken in the name of the user's account with the subscriber. This action could further urge the authorized entity/true customer to timely correspond with the subscriber about such improper actions and undertake various anti-fraud actions with the subscriber. In either case, the process could generally proceed back to step 1 as needed.

The invention 10 could further comprise of an authentication verification system having a subscriber's computer processor that can access an authorized user database that can be accessed by the computer processor. The authorized user database being configured to associate an authorized user with an identification of a communication device belonging or associated with the authorized user, said communication device configured to communicate over a cell phone network. The token server could have a control module, a communication module and authentication module. The control module (e.g., a token generator, authorized user authentication request identifier generator) once contacted activated by the subscriber's computer processor with an authorized user authentication request could create a token based at least upon an auto-generated unique identity, wherein the created token that is unique to and not previously known to the authorized user. The communication module could be configured to then transmit the created token to the personal communication device through the cell phone network, and an authentication module, also connected to the computer processor configured to receive the created token sent back the cell phone network from the authenticated users communication device which is different from the communication device being used by the requesting party to request access to the secure system and website. When the authentication module activates upon receipt of the created token access to the account in response to the verification of received token from user within predetermined amount of time.

Upon receipt of the access/transaction request by an requesting entity to the secured system or website as controlled by the computer processor or server(s), the subscriber could retrieve its identification information (allowing the token server to authenticate the token request as coming from a properly authored subscriber) and the identifier of the customer allegedly requesting access/transaction and transmit this combined data within a token request directed to token server.

In response to receipt of this token request, the token server could compare the received subscriber's identification information with its database of authorized subscribers. If not authenticated (subscriber's identification information does not match any of the entries of its database of authorized subscribers) then non-authenticated token requests would not result in token generation and could be suitably processed in some other manner by the token server. If on the other hand, the token request is appropriately authenticated, the token server will generate the unique one-time token using random number generation; encryption; one-way hash function or other suitable means. The token server then could bundle the generated token with the customer's identifier (e.g., mobile telephone number.)

The token server then could corresponds with the communication module with this combined information/data to cause the communication module to create and transmit a SMS (Short Message Service) message to the customer's personal communication device (e.g., the device being previously associated with the customer's identifier) through an appropriate telecommunications systems (e.g., a cell phone network). The token server can then also communicate back with the subscriber sending it a job identifier that is associated generated token/user authentication request so that the subscriber could subsequently interact with the token server to monitor those activities and outside responses (e.g., poll for results) as they pertain to the generated token/requesting entity.

The SMS message or authentication request as received by the authorized entity/true customer (and not being received an accessing entity who is not the authorized entity/true customer of the subscriber) can be readily understood by the authorized entity/true customer as being ultimately issued at the behest or by the subscriber in relation to a current transaction being requested by an requesting entity initially identifying itself to the subscriber as being the authorized entity/true customer. The receipt of SMS authentication request could also be used to inform receiving authorized entity/true customer that they need to timely return the authentication request/token “back to” the telecommunications module at the same number or short code from which the original SMS authentication request. The authorized entity/true customer could be further so informed that this token return must be completed within the time period as also disclosed in the SMS authentication request. The SMS authentication request could further inform the recipient that failure to timely to timely retransmit/“return” the authentication request/token would result in the blocking/refusal by the subscriber to complete the requested access/transaction and that if the recipient.

If the requesting entity is not authorized entity/true customer, then generally speaking they will not be the recipient of SMS authentication request. This inability to return the authentication request could result in the “unauthorized” requesting entity being allowed to complete the access/transaction that it has requested.

Once the token as properly sent back by the authorized entity/true customer (e.g., recipient of the SMS authentication request) is received at the telecommunication module within the allotted time and is transmitted to the token server, the token server can process the returned token (matching it with the transmitted token with the time allotted by the system) as authenticating the requesting entity and authorized entity as being one and the same.

On this basis, the token server could create data to inform the subscriber when so polled by the subscriber that requesting entity authentication is confirmed. If the token server does not get the token returned to it within the designated time or if the return token does not match the sent token then the token server will establish the entity as non-authenticated or denied. If the token server is still waiting for the token to be returned within the designated or allotted time by the invention, then the token server can create data for the subscriber to temporarily establish the authentication status as pending.

During this timeframe, the subscriber can repeatedly poll the token server regarding its authentication request. The token server could reply (transmit the appropriate data, e.g. token status qualifiers) to the subscriber during this action that authentication is pending, confirmed, or denied. Depending on the status qualifiers received, the subscriber can take suitable actions (temporality halt access; deny access, allow access, and engage in further security actions and protocols) in relation to the access/transactions requested by the entity.

### CONCLUSION

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

As disclosed above, the invention may be viewed as a customer authentication/verification/identification method and system for a secured site/system. The invention confirms authorization of an entity requesting access/transaction with the secured site/system entities (e.g., subscriber's customer as properly authorized by the subscriber) to the subscriber's secured system using a communication means that is different from the one being used by the requesting entity trying to access/transact with the subscriber's secure system/site. The invention also prevents unauthorized entities from sending needed information to the invention to identifying them as authorized entities with permission to access the subscriber's secured system/site. The invention can simultaneously inform an authorized entity of unauthorized activity being done in the name of its identity as relating to secure system/site to which the authorized entity has a relationship. The invention further can be seen as requiring some positive action by the authorized entity to confirm the authorized entity's authority to interact with a secured system/site and to allow the authorized entity's activities as they relate to the secured system/website.

What is claimed is:

1. A method of authenticating a requesting party using a first communication device to access a secure system or website as an authorized user of the secure system or website, the authorized user having a user account with the secure system or website, the method comprising of the following steps, but not necessarily in the order shown:
(A) generating a request for authorized user authentication by the secure system or website, the request for authorized user authentication further containing an identifier of a second communication device that is associated with the authorized user, the second communication device being different from the first communication device;
(B) sending the request for authorized user authentication to a token server;
(C) generating the token by the token server;
(D) transmitting the token to the second communication device based on the identifier; and
(E) using the retransmission or lack of retransmission of the token from the second communication device back to the token server to confirm or deny authentication of the requesting entity as the authorized user allowed to access the secure system or website.

2. The process of claim 1 further comprising a step of creating a token request identifier associated with the request for authorized user authentication and transmitting the said token request identifier to the secure system or website to allow the polling by secure system or website of the token server for any authentication results.

3. The process of claim 1 further comprises a step of retransmitting the token back to the token server from the second communication device.

4. The process of claim 1 further comprises a step of matching the time between transmission and retransmission of the token against a predetermined value of time.

5. The process of claim 1 wherein the using the transmission or retransmission of the token further comprises a step of matching the token as transmitted by the token server with the token as received by the token server.

6. The process of claim 1 wherein sending the request for authorized user authentication is sent on the same communications network that the requesting party is attempting to access the secure system or website.

7. The process of claim 1 wherein the second communication device uses a different type of a communication network than does the first communication device.

8. The process of claim 1 wherein the transmitting the token to the second communication device based on the identifier occurs on a communication network that is different from a communication network as used by the first communication device.

9. The process of claim 1 wherein the second communication device uses a SMS communication network to receive and retransmit the token while the first communication device being used by the requesting party to access the secure system or website uses an internet communication network.

10. The process of claim 1 wherein the second communication device is different from the first communication device by being a different type of a communication device from the first communication device.

11. The process of claim 1 wherein the token is not previously known to the authorized user.

12. The process of claim 1 wherein the token is unique to the authorized user.

13. The process of claim 1 further comprising a step of activating the authentication module to confirm authentication when the token as retransmitted by the second communication device is received by the authentication module within predetermined amount of time.

14. The process of claim 14 whether the step of activating an authentication module to confirm authentication further comprises a step of transmitting the authentication to the secure system or website when polled by the secure system or website.

15. The process of claim 1 wherein the transmitting the token to the second communication device based on the identifier further comprises a step of activating a communication module to transmit through the cell phone network the token to the second communication device.

16. The process of claim 1 wherein the transmitting the token to the second communication device based on the identifier is done over a cell phone network.

17. The process of claim 1 wherein the retransmitting of the token to token server by the second communication device is done over a cell phone network.

18. The process of claim 1 further comprising a step of notifying the authorized user of irregular activity pertaining to the authorized user's user account when authentication is denied by the token server.

19. The process of claim 1 further comprising a step of denying requesting party access to secure system or website when authentication is denied by the token server.
